(19) United States
(12) Patent Application Publication
(10) Pub. No.: US 2016/0157254 A1
(43) Pub. Date: Jun. 2, 2016

(54) METHODS AND APPARATUS FOR CONTROL INFORMATION RESOURCE ALLOCATION FOR D2D COMMUNICATIONS

(71) Applicant: Samsung Electronics Co., Ltd., Suwon-si (KR)

(72) Inventors: Thomas David Novlan, Dallas, TX (US); Boon Loong Ng, Dallas, TX (US); Jianzhong Zhang, Plano, TX (US)

(21) Appl. No.: 14/949,530

(22) Filed: Nov. 23, 2015

Related U.S. Application Data
(60) Provisional application No. 62/085,026, filed on Nov. 26, 2014.
(60) Provisional application No. 62/101,857, filed on Jan. 9, 2015.

(51) Int. Cl. H04W 72/10; H04W 76/02

(52) U.S. Cl. CPC H04W 72/10; H04W 76/023

(57) ABSTRACT

A method and an apparatus for control information resource allocation for device to device (D2D) communications. The method includes receiving a network allocation of resource configuration to the UE. The method further includes selecting a set of resources from the network allocation of resource configuration based on a priority rule. The method also includes transmitting the selected set of resources to one or more other UEs.

### CROSS-REFERENCE TO RELATED APPLICATION(S) AND CLAIM OF PRIORITY

This application also claims priority under 35 U.S.C. §119(e) to U.S. Provisional Patent Application No. 62/085,026 filed on Nov. 26, 2014, entitled “METHODS AND APPARATUS FOR CONTROL INFORMATION RESOURCE ALLOCATION FOR D2D COMMUNICATIONS.” The above-identified provisional patent application is hereby incorporated by reference in its entirety. This application also claims priority under 35 U.S.C. §119(e) to U.S. Provisional Patent Application No. 62/101,857 filed on Jan. 9, 2015, entitled “METHODS AND APPARATUS FOR A D2D RELAY COMMUNICATIONS PROTOCOL.” The above-identified provisional patent applications are hereby incorporated by reference in its entirety.

### TECHNICAL FIELD

This disclosure relates generally to wireless communication systems. More specifically, this disclosure relates to device-to-device (D2D) resource allocation methods.

### BACKGROUND

D2D or “ad-hoc” networks can be established by direct communication between mobile devices without an intermediary access point. Some devices can communicate both on traditional networks and using D2D techniques. Improved systems and methods are desirable.

### SUMMARY

Embodiments of the present disclosure provide for control information resource allocation for device to device (D2D) communications.

In one embodiment, a user equipment (UE) configured to communicate with a plurality of UEs. The UE includes a transceiver and one or more processors operably connected to the transceiver. The one or more processors configured to receive, via the transceiver, a network allocation of resource configurations from a base station, select a set of resources from the network allocation of resource configurations based on a priority rule; and transmit, via the transceiver, the selected set of resources to one or more other UEs.

In another embodiment, a base station (BS) configured to communicate with a plurality of UEs. The base station includes a transceiver and one or more processors operably connected to the transceiver. The one or more processors configured to configure a network allocation of resource configurations, and transmit, via the transceiver, the network allocation of resource configurations to a user equipment (UE).

In yet another embodiment, a method for a user equipment (UE) communicating with a plurality of UEs. The method includes receiving a network allocation of resource configuration to the UE. The method further includes selecting a set of resources from the network allocation of resource configuration based on a priority rule. The method also includes transmitting the selected set of resources to one or more other UEs.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to this disclosure;

FIG. 2 illustrates an example eNodeB (eNB) according to this disclosure;

FIG. 3 illustrates an example user equipment (UE) according to this disclosure;

FIGS. 4A and 4B illustrate example wireless transmit and receive paths according to this disclosure;

FIG. 5 illustrates an example structure for a downlink (DL) transmission time interval (TTI) according to various embodiments of the present disclosure;

according to illustrative embodiments of this disclosure;

FIG. 6 illustrates an LTE device-to-device communications network according to the various embodiments of the present disclosure;

FIG. 7 illustrates a cellular resource allocation procedure according to the various embodiments of the present disclosure;

FIG. 8 illustrates centralized and distributed resource allocation for D2D communication according to various embodiments of the present disclosure;

FIG. 9 illustrates a different SA offset and D2D data periodicity according to the various embodiments of the present disclosure;

FIG. 10 illustrates SA and data resources according to various embodiments of the present disclosure;

FIG. 11 illustrates an exemplary method 1100 for control information resource allocation for D2D communications for an eNB according to various embodiments of the present disclosure;

FIG. 12 illustrates an exemplary method 1100 for control information resource allocation for D2D communications for a UE according to various embodiments of the present disclosure;

FIG. 13 illustrates a D2D scheduling period for D2D SA time locations according to various embodiments of the present disclosure;

FIG. 14 illustrates a relay operation for one or more UEs to act as a UE-to-Network relay according to various embodiments of the present disclosure;

FIG. 15 illustrates a D2D relay deployment according to various embodiments of the present disclosure;

FIG. 16 illustrates an exemplary process for relay selection according to the various embodiments of the present disclosure;

FIG. 17 illustrates a D2D relay service continuity according to various embodiments of the present disclosure;

FIG. 18 illustrates an exemplary method for service continuity from network link to relay link according to various embodiments of the present disclosure; and

FIG. 19 illustrates an exemplary method 1900 for service continuity from relay link to network link according to various embodiments of the present.

### DETAILED DESCRIPTION

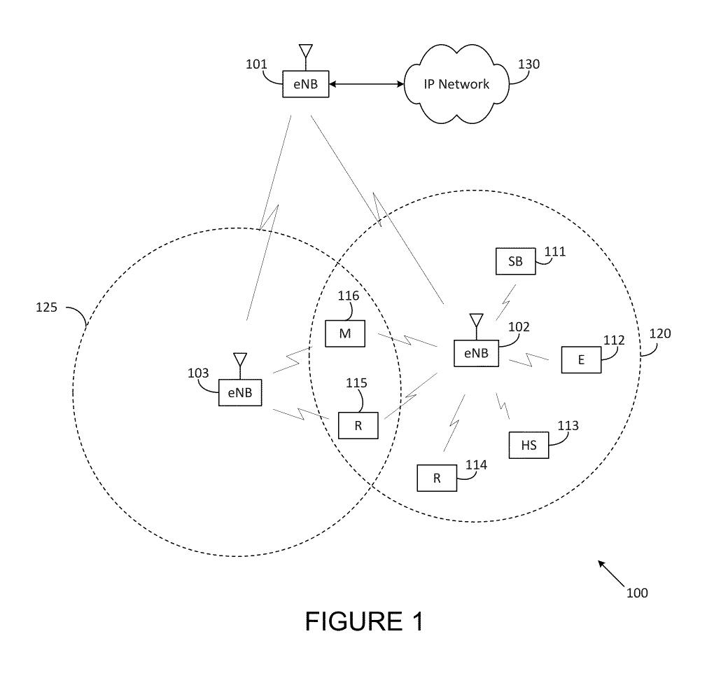

FIGS. 1 through 19, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein:

[1] 3GPP TS 36.211 v11.2.0, “E-UTRA, Physical channels and modulation.”

[2] 3GPP TS 36.212 v11.2.0, “E-UTRA, Multiplexing and Channel coding”

[3] 3GPP TS 36.213 v11.2.0, “E-UTRA, Physical Layer Procedures”

[4] 3GPP TR 36.872 V12.0.0, “Small cell enhancements for E-UTRA and E-UTRA—Physical layer aspects”

[5] 3GPP TS 36.133 v11.7.0, “E-UTRA Requirements for support of radio resource management”

FIG. 1 illustrates an example wireless network 100 according to this disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes an eNodeB (eNB) 101, an eNB 102, and an eNB 103. The eNB 101 communicates with the eNB 102 and the eNB 103. The eNB 101 also communicates with at least one Internet Protocol (IP) network 130, such as the Internet, a proprietary IP network, or other data network.

The eNB 102 provides wireless broadband access to the network 130 for a first plurality of user equipments (UEs) within a coverage area 120 of the eNB 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The eNB 103 provides wireless broadband access to the network 130 for a second plurality of UEs within a coverage area 125 of the eNB 103. The second plurality of UEs includes the UE 115 and the UE 116. In some embodiments, one or more of the eNBs 101-103 may communicate with each other and with the UEs 111-116 using 5G, LTE, LTE-A, WiMAX, WiFi, or other wireless communication techniques.

Depending on the network type, other well-known terms may be used instead of “eNodeB” or “eNB,” such as “base station” or “access point.” For the sake of convenience, the terms “eNodeB” and “eNB” are used in this patent document to refer to network infrastructure components that provide wireless access to remote terminals. Also, depending on the network type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used in this patent document to refer to remote wireless equipment that wirelessly accesses an eNB, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with eNBs, such as the coverage areas 120 and 125, may have other shapes, including irregular shapes, depending upon the configuration of the eNBs and variations in the radio environment associated with natural and man-made obstructions.

As described in more detail below, wireless network 100 provides for control information resource allocation for D2D communications. For example, eNBs 101-103 may provide allocation resources to the UEs 111-116. Similarly, the UEs 111-116 may receive the allocation resources and perform a feasibility measurement.

Although FIG. 1 illustrates one example of a wireless network 100, various changes may be made to FIG. 1. For example, the wireless network 100 could include any number of eNBs and any number of UEs in any suitable arrangement. Also, the eNB 101 could communicate directly with any number of UEs and provide those UEs with wireless broadband access to the network 130. Similarly, each eNB 102-103 could communicate directly with the network 130 and provide UEs with direct wireless broadband access to the network 130. Further, the eNB 101, 102, and/or 103 could provide access to other or additional external networks, such as external telephone networks or other types of data networks.

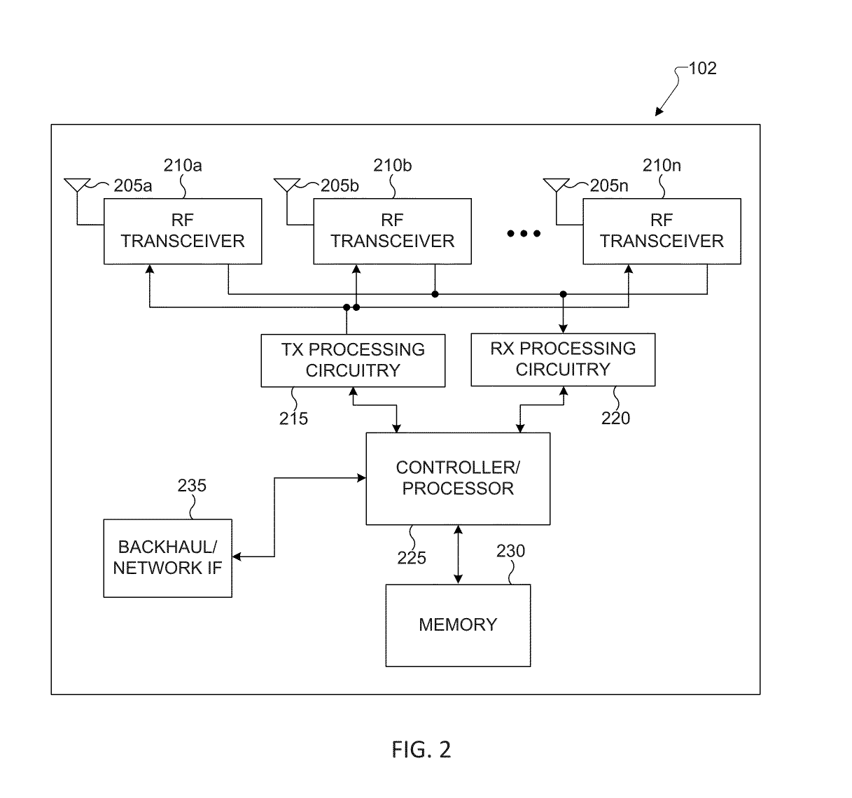

FIG. 2 illustrates an example eNB 102 according to this disclosure. The embodiment of the eNB 102 illustrated in FIG. 2 is for illustration only, and the eNBs 101 and 103 of FIG. 1 could have the same or similar configuration. However, eNBs come in a wide variety of configurations, and FIG. 2 does not limit the scope of this disclosure to any particular implementation of an eNB.

As shown in FIG. 2, the eNB 102 includes multiple antennas 205a-205n, multiple RF transceivers 210a-210n, transmit (TX) processing circuitry 215, and receive (RX) processing circuitry 220. The eNB 102 also includes a controller/processor 225, a memory 230, and a backhaul or network interface 235.

The RF transceivers 210a-210n receive, from the antennas 205a-205n, incoming RF signals, such as signals transmitted by UEs in the network 100. The RF transceivers 210a-210n down-convert the incoming RF signals to generate IF or baseband signals. The IF or baseband signals are sent to the RX processing circuitry 220, which generates processed baseband signals by filtering, decoding, and/or digitizing the baseband or IF signals. The RX processing circuitry 220 transmits the processed baseband signals to the controller/processor 225 for further processing.

The TX processing circuitry 215 receives analog or digital data (such as voice data, web data, e-mail, or interactive video game data) from the controller/processor 225. The TX processing circuitry 215 encodes, multiplexes, and/or digitizes the outgoing baseband data to generate processed baseband or IF signals. The RF transceivers 210a-210n receive the outgoing processed baseband or IF signals from the TX processing circuitry 215 and up-converts the baseband or IF signals to RF signals that are transmitted via the antennas 205a-205n.

The controller/processor 225 can include one or more processors or other processing devices that control the overall operation of the eNB 102. For example, the controller/processor 225 could control the reception of forward channel signals and the transmission of reverse channel signals by the RF transceivers 210a-210n, the RX processing circuitry 220, and the TX processing circuitry 215 in accordance with well-known principles. The controller/processor 225 could support additional functions as well, such as more advanced wireless communication functions. For instance, the controller/processor 225 could support beam forming or directional routing operations in which outgoing signals from multiple antennas 205a-205n are weighted differently to effectively steer the outgoing signals in a desired direction. Any of a wide variety of other functions could be supported in the eNB 102 by the controller/processor 225. In some embodiments, the controller/processor 225 includes at least one microprocessor or microcontroller.

The controller/processor 225 is also capable of executing programs and other processes resident in the memory 230, such as a basic OS. The controller/processor 225 can move data into or out of the memory 230 as required by an executing process.

The controller/processor 225 is also coupled to the backhaul or network interface 235. The backhaul or network interface 235 allows the eNB 102 to communicate with other devices or systems over a backhaul connection or over a network. The interface 235 could support communications over any suitable wired or wireless connection(s). For example, when the eNB 102 is implemented as part of a cellular communication system (such as one supporting 5G, LTE, or LTE-A), the interface 235 could allow the eNB 102 to communicate with other eNBs over a wired or wireless backhaul connection. When the eNB 102 is implemented as an access point, the interface 235 could allow the eNB 102 to communicate over a wired or wireless local area network or over a wired or wireless connection to a larger network (such as the Internet). The interface 235 includes any suitable structure supporting communications over a wired or wireless connection, such as an Ethernet or RF transceiver.

The memory 230 is coupled to the controller/processor 225. Part of the memory 230 could include a RAM, and another part of the memory 230 could include a Flash memory or other ROM.

As described in more detail below, eNB 102 may implement a network that indicates allocation resources to the UE.

Although FIG. 2 illustrates one example of eNB 102, various changes may be made to FIG. 2. For example, the eNB 102 could include any number of each component shown in FIG. 2. As a particular example, an access point could include a number of interfaces 235, and the controller/processor 225 could support routing functions to route data between different network addresses. As another particular example, while shown as including a single instance of TX processing circuitry 215 and a single instance of RX processing circuitry 220, the eNB 102 could include multiple instances of each (such as one per RF transceiver). Also, various components in FIG. 2 could be combined, further subdivided, or omitted and additional components could be added according to particular needs.

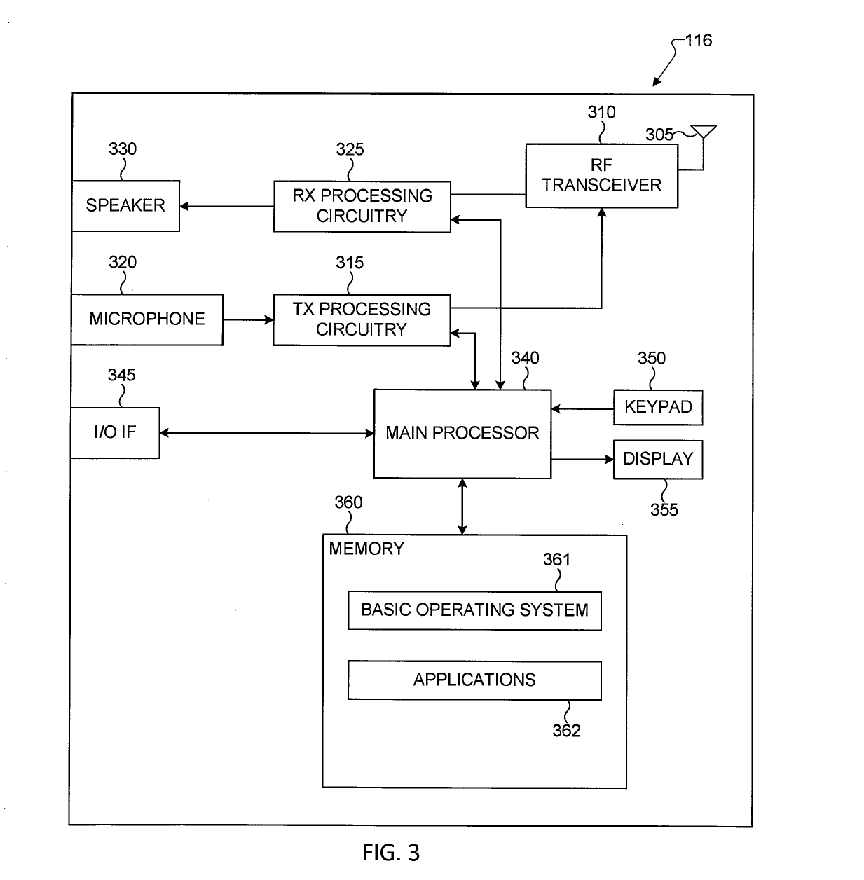

FIG. 3 illustrates an example UE 116 according to this disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes an antenna 305, a radio frequency (RF) transceiver 310, transmit (TX) processing circuitry 315, a microphone 320, and receive (RX) processing circuitry 325. The UE 116 also includes a speaker 330, a main processor 340, an input/output (I/O) interface (IF) 345, a keypad 350, a display 355, and a memory 360. The memory 360 includes a basic operating system (OS) program 361 and one or more applications 362.

The RF transceiver 310 receives, from the antenna 305, an incoming RF signal transmitted by an eNB of the network 100. The RF transceiver 310 down-converts the incoming RF signal to generate an intermediate frequency (IF) or baseband signal. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as for voice data) or to the main processor 340 for further processing (such as for web browsing data).

The TX processing circuitry 315 receives analog or digital voice data from the microphone 320 or other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305.

The main processor 340 can include one or more processors or other processing devices and execute the basic OS program 361 stored in the memory 360 in order to control the overall operation of the UE 116. For example, the main processor 340 could control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller.

The main processor 340 is also capable of executing other processes and programs resident in the memory 360. The main processor 340 can move data into or out of the memory 360 as required by an executing process. In some embodiments, the main processor 340 is configured to execute the applications 362 based on the OS program 361 or in response to signals received from eNBs or an operator. The main processor 340 is also coupled to the I/O interface 345, which provides the UE 116 with the ability to connect to other devices such as laptop computers and handheld computers. The I/O interface 345 is the communication path between these accessories and the main processor 340.

The main processor 340 is also coupled to the keypad 350 and the display unit 355. The operator of the UE 116 can use the keypad 350 to enter data into the UE 116. The display 355 may be a liquid crystal display or other display capable of rendering text and/or at least limited graphics, such as from web sites.

The memory 360 is coupled to the main processor 340. Part of the memory 360 could include a random access memory (RAM), and another part of the memory 360 could include a Flash memory or other read-only memory (ROM).

As described in more detail below, UE 116 implements an apparatus that receives the allocation resources from the network and performs a feasibility measurement

Although FIG. 3 illustrates one example of UE 116, various changes may be made to FIG. 3. For example, various components in FIG. 3 could be combined, further subdivided, or omitted and additional components could be added according to particular needs. As a particular example, the main processor 340 could be divided into multiple processors, such as one or more central processing units (CPUs) and one or more graphics processing units (GPUs). Also, while FIG. 3 illustrates the UE 116 configured as a mobile telephone or smartphone, UEs could be configured to operate as other types of mobile or stationary devices.

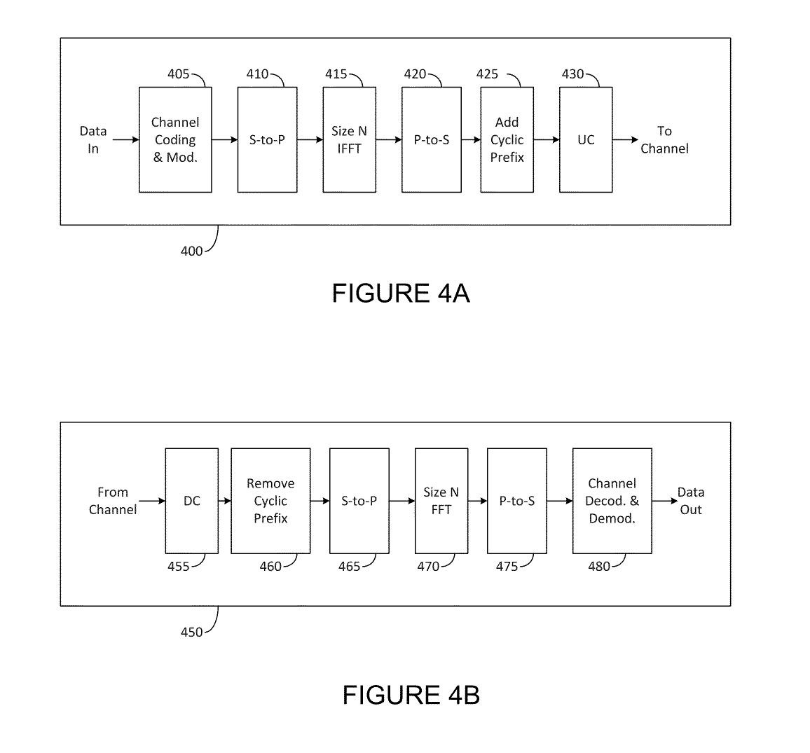

FIGS. 4A and 4B illustrate example wireless transmit and receive paths according to this disclosure. In the following description, a transmit path 400 may be described as being implemented in an eNB (such as eNB 102), while a receive path 450 may be described as being implemented in a UE (such as UE 116). However, it will be understood that the receive path 450 could be implemented in an eNB and that the transmit path 400 could be implemented in a UE. In some embodiments, the transmit path 400 and receive path 450 are configured to provides for control information resource allocation for D2D communications.

The transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a serial-to-parallel (S-to-P) block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the eNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the eNB 102 arrives at the UE 116 after passing through the wireless channel, and reverse operations to those at the eNB 102 are performed at the UE 116. The down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time domain signals. The size N FFT block 470 performs an FFT algorithm to generate N parallel frequency-domain signals. The parallel-to-serial block 475 converts the parallel frequency-domain signals to a sequence of modulated data symbols. The channel decoding and demodulation block 480 demodulates and decodes the modulated symbols to recover the original input data stream.

Each of the eNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to eNBs 101-103 and may implement a receive path 450 for receiving in the downlink from eNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, could be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths, various changes may be made to FIGS. 4A and 4B. For example, various components in FIGS. 4A and 4B could be combined, further subdivided, or omitted and additional components could be added according to particular needs. Also, FIGS. 4A and 4B are meant to illustrate examples of the types of transmit and receive paths that could be used in a wireless network. Any other suitable architectures could be used to support wireless communications in a wireless network.

FIG. 5 illustrates an example structure for a DL transmission time interval (TTI) 500 according to embodiments of the present disclosure. An embodiment of the DL TTI structure 500 shown in FIG. 5 is for illustration only. Other embodiments can be used without departing from the scope of the present disclosure.

As illustrated in FIG. 5, a DL signaling uses orthogonal frequency division multiplexing (OFDM) and a DL TTI includes N=14 OFDM symbols in the time domain and K resource blocks (RBs) in the frequency domain. A first type of control channels (CCHs) is transmitted in a first N1 OFDM symbols 510 including no transmission, N1=0. Remaining N-N1 OFDM symbols are primarily used for transmitting physical downlink control channels (PDSCH) 520 and, in some RBs of a TTI, for transmitting a second type of CCHs (ECCHs) 530.

An eNB 103 also transmits primary synchronization signals (PSS) and secondary synchronization signals (SSS), so that UE 116 synchronizes with the eNB 103 and performs cell identification. There are 504 unique physical-layer cell identities. The physical-layer cell identities are grouped into 168 unique physical-layer cell-identity groups which of each group contains three unique identities. The grouping is such that each physical-layer cell identity is part of one and only one physical-layer cell-identity group. A physical-layer cell identity is thus uniquely defined by a number in the range of 0 to 167, representing the physical-layer cell-identity group, and a number in the range of 0 to 2, representing the physical-layer identity within the physical-layer cell-identity group. Detecting a PSS enables a UE 116 to determine the physical-layer identity as well as a slot timing of the cell transmitting the PSS. Detecting a SSS enables the UE 116 to determine a radio frame timing, the physical-layer cell identity, a cyclic prefix length as well as the cell uses ether a frequency division duplex (FDD) or a time division duplex (TDD) scheme.

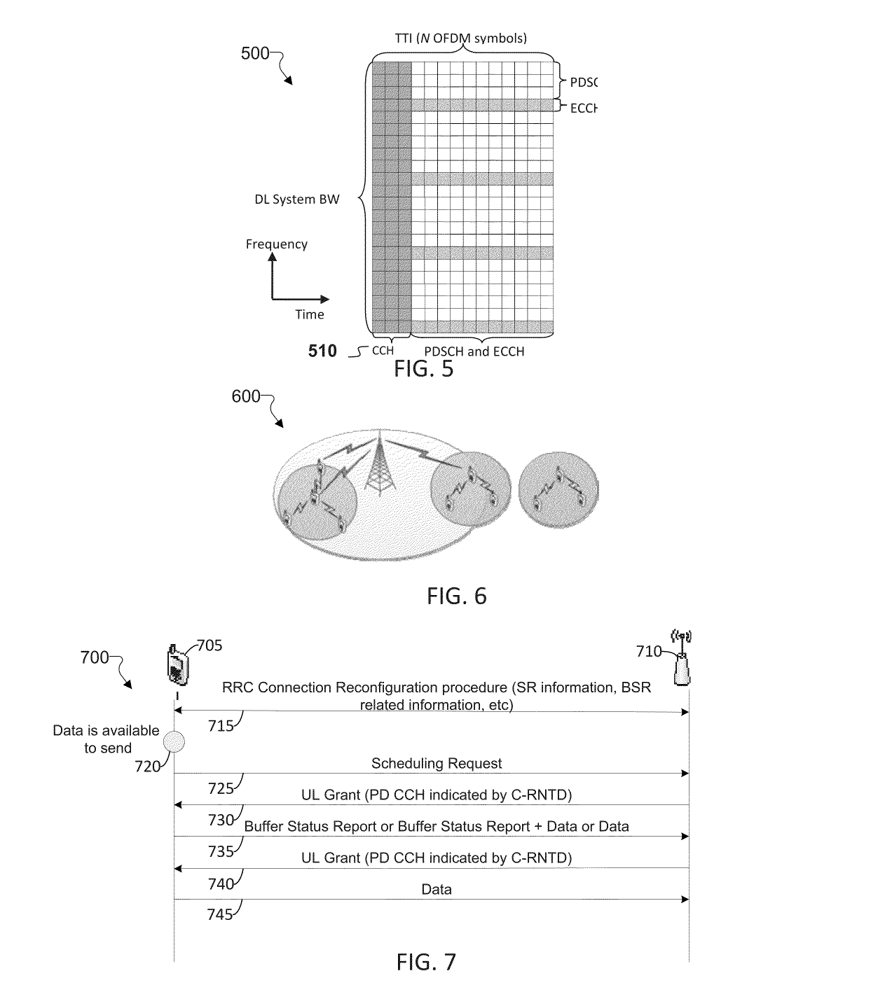

FIG. 6 illustrates an LTE device-to-device communications network 600 according to the various embodiments of the present disclosure.

Cellular communication networks have been designed to establish wireless communication links between mobile devices and fixed communication infrastructure components (such as base stations or access points) that serve users in a wide or local geographic range. However, a wireless network can also be implemented utilizing only device-to-device (D2D) communication links without the need for fixed infrastructure components. This type of network is typically referred to as an “ad-hoc” network. A hybrid communication network can support devices that connect both to fixed infrastructure components and to other D2D-enabled devices.

D2D communication may be used to implement many kinds of services that are complementary to the primary communication network or provide new services based on the flexibility of the network topology. D2D multicast communication such as broadcasting or groupcasting is a potential means for D2D communication where mobile devices are able to transmit messages to all in-range D2D-enabled mobile devices or a subset of mobile devices which are members of particular group. Additionally networks may require devices to operate in near simultaneous fashion when switching between cellular and D2D communication modes

FIG. 7 illustrates a cellular resource allocation procedure 700 according to the various embodiments of the present disclosure.

In the case of cellular unicast operation, resources for UE transmission are allocated per TTI. This level of granularity is beneficial to support very dynamic allocation and provides flexibility to accommodate different numbers of simultaneously transmitting users and different data rates.

In operation 710, the UE 705 and BS 710 perform a radio resource control (RRC) connection reconfiguration procedure. The RRC connection reconfiguration procedure includes scheduling request (SR) information, BSR related information, etc. In operation 720, the UE 705 includes data that becomes available to send. In operation 725, the UE 705 transmits a scheduling request to the BS 710. In operation 730, the BS 710 transmits a UL grant including a PDCCH indicated by C-RNTI to the UE 730. In operation 735, the UE transmits a buffer status report, data, or the buffer status report and data to the BS 710. In operation 740, the BS transmits a UL grant including a PDCCH indicated by a C-RNTI to the UE 705. In operation 745, the UE transmit the data to the BS 710.

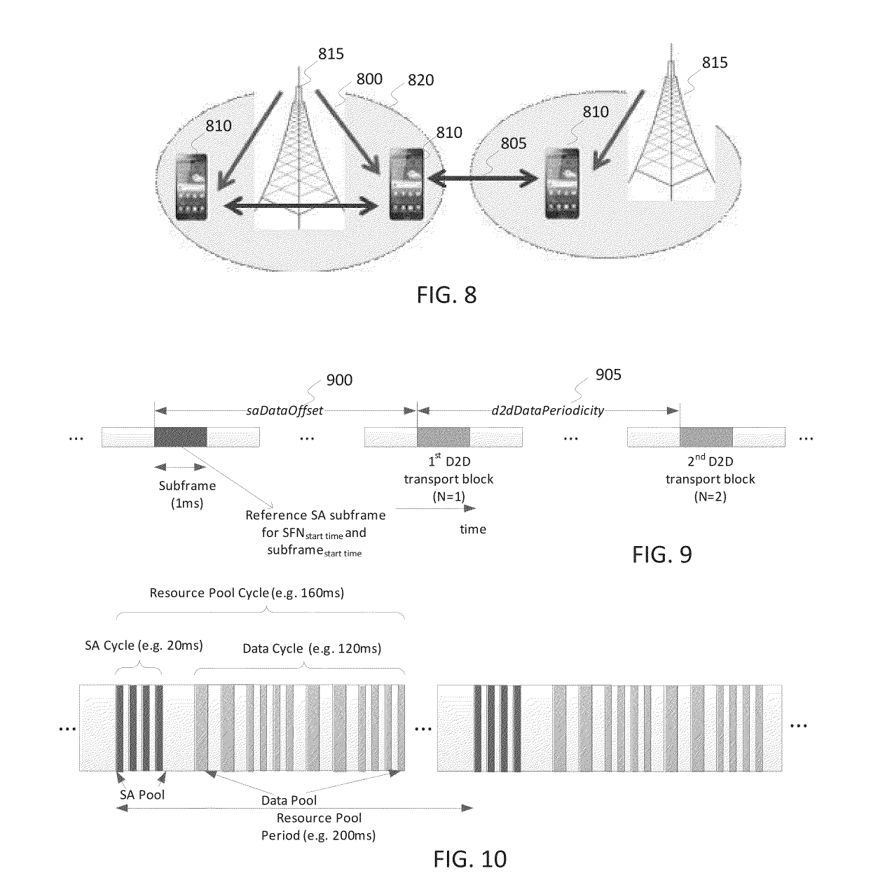

FIG. 8 illustrates centralized resource allocation 800 and distributed resource allocation 805 for D2D communication according to various embodiments of the present disclosure.

D2D also requires resource allocation mechanisms since multiple UEs 810 may have a need to utilize the same time/frequency resources as other D2D or cellular UEs 810. This resource allocation In addition to resource allocation signaling for the transmitting UEs, in the case of D2D, receiving UEs 810 may also require resource allocation signaling in order to determine which time/frequency resources to monitor to receive the transmissions of one of more D2D UEs 810. Different resource allocation granularity may need to be supported depending on multiple factors including deployment scenario (in/outside network coverage) and traffic types (e.g. unicast, groupcast, video, etc.).

Traditionally for centralized resource allocation 800, a central controller like the eNB 815 collects all the channel state information of every UE 810 in the cell 820 and allocates the available resources to maximize the throughput according to fairness and power constraints. For UEs 810 within network coverage, the eNB 815 may be responsible for allocating resources for a group of UEs 810. Based on the eNB 815 (or possibly group leader UE 810) resource allocation the transmitting UEs 810 may provide a scheduling assignment signaling indicating the resources the Rx UEs 810 should monitor for reception of the D2D data.

On the other hand, especially considering the out-of-network coverage scenario, UEs 810 can determine their resource allocation in a distributed resource allocation 805. Simple random resource selection may be considered as a baseline distributed approach with low overhead and scalability. One drawback of such an approach is that collisions are possible among broadcasting UEs 810. Thus, an implicit coordination (e.g., carrier sensing) and/or explicit coordination (e.g., scheduling assignment transmission) would be required to prevent collisions and mitigate interference.

FIG. 9 illustrates a different SA offset 900 and D2D data periodicity 905 according to the various embodiments of the present disclosure.

The D2D data transmission time/frequency resources may be independently configured from the time/frequency resources utilized by the scheduling assignment. For example, the period between SA transmissions and new data transmissions may be larger than the data transmission period to accommodate different SA periods and variable amounts of cellular time resources multiplexed with D2D subframes in the overall LTE frame structure. Alternatively the period between SA transmissions and the new data transmission period may be shorter to accommodate larger data transmission periods and more infrequency data traffic, while minimizing the delay between receiving the control message (e.g. SA) and the start of the first data transmission.

FIG. 10 illustrates SA and data resources according to various embodiments of the present disclosure.

As a result, resource pools can be defined as periodic sets of time/frequency resources which UEs utilize for a given D2D transmission and receiving UEs can search for potential transmissions, including scheduling assignments and data transmissions as shown in FIG. 6.

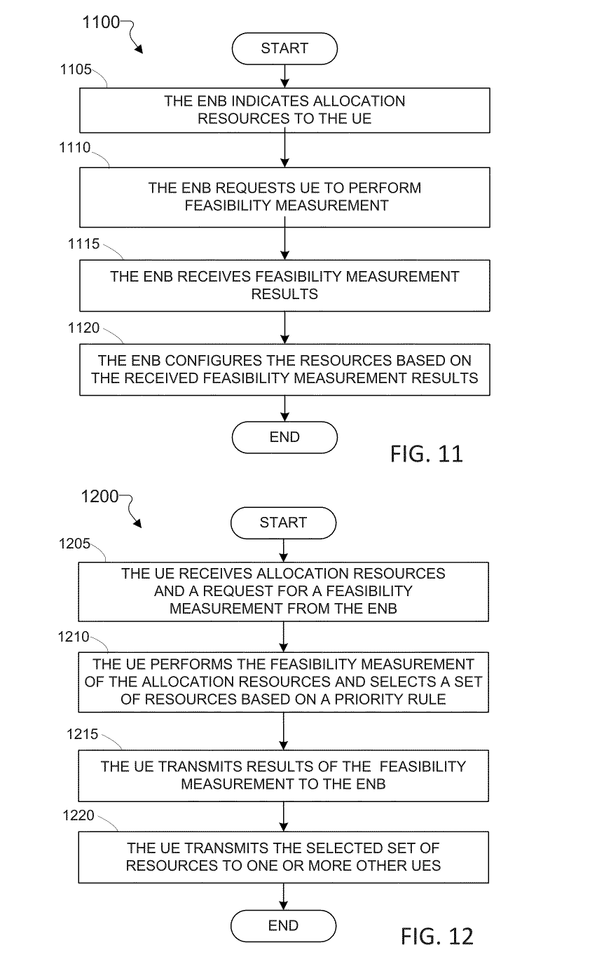

FIG. 11 illustrates an exemplary method 1100 for control information resource allocation for D2D communications for an eNB according to various embodiments of the present disclosure.

In operation 1105, the eNB indicates allocation resources to the UE. In operation 1110, the eNB requests the UE to perform a feasibility measurement. In operation 1115, the eNB receives results of the feasibility measurements. In operation 1120, the eNB configures the allocation resources based on the received feasibility measurement results.

FIG. 12 illustrates an exemplary method 1200 for control resource allocation for D2D communications for a UE according to various embodiments of the present disclosure.

In operation 1205, the UE receives allocation resources and a request for a feasibility measurement from the eNB.

In operation 1210, the UE performs the feasibility measurement of the allocation resources and selects a set of resources based on a priority rule. In certain embodiments, the priority rules includes a priority indicator that is provided by a higher level signaling for each of the resource pools. The priority rule can also be implicitly carried by an identification for each of the plurality of resource pools. The priority rule can also include a priority indication based on a type of data transmission associated with each of the resources pools.

In operation 1215, the UE transmits the results of the feasibility measurement to the eNB. In operation 1220, the UE transmits a set of resources to one or more other UEs.

FIG. 13 illustrates a D2D scheduling period 1200 for D2D SA time locations according to various embodiments of the present disclosure.

In certain embodiments, the eNB indicates to a D2D UE a set of time domain resources for one or more transmissions of D2D control channel information such as scheduling assignments (SA). The indication from the eNB may be provided as part of a SA grant utilizing physical layer downlink control information (DCI) signaling or configured by higher layers (e.g. RRC). The control information for the time domain resources can be included in an SA grant.

After the D2D transmitter UE has received the SA grant, the D2D transmitter UE transmits the SA and one or more SA retransmissions according to the set of time domain resources indicated 1211-1213 within a SA period 1210 that is repeated according to a configured periodicity.

After a D2D receiver UE has received the SA, the D2D receiver UE receives D2D data transport blocks from the time/frequency domain indicated by the SA 1220. The SA grant can include a field indicating a set of time domain resources for the transmission (T-RPT) of one or more SA messages.

In a first example, the SA T-RPT field may comprise a transmission pattern. For example a bitmap may correspond to a set of valid SA subframes and a ‘1’ in the bitmap indicates a transmission opportunity, while a ‘0’ in the bitmap indicates a transmission is not performed by the Tx UE. The valid SA subframes may be preconfigured or indicated by higher layer signaling (e.g. SIB). The SA T-RPT pattern bitmap may one-to-one map to the valid indicated SA subframes or may map according to a predefined or configured manner.

In a second example, assuming D2D UEs are configured by the higher layer (e.g. RRC) or preconfigured with a set of SA T-RPT patterns (e.g. subframe bitmaps) where each pattern is labeled with an index, the signaling in the SA grant can indicate the retransmission time pattern index. The set of SA T-RPT patterns can have default values in the absence of higher layer signaling. An example is shown in Table 1 for a 2-bit field indicating up to 4 retransmission time patterns. Each higher layer configured SA T-RPT pattern can be a bitmap marking the subframes within the set of subframes reserved for SA transmissions (Table 2).

TABLE 1
SA T-RPT pattern indicator

| SA T-RPT pattern indicator | SA T-RPT pattern index |
|---|---|
| 00 | 0 |
| 01 | 1 |
| 10 | 2 |
| 11 | 3 |

TABLE 2
SA T-RPT indicated by bitmap

| SA T-RPT pattern index | SA T-RPT pattern Bitmap |
|---|---|
| 0 | 1 0 1 0 |
| 1 | 1 0 0 1 |
| 2 | 1 1 0 0 |
| 3 | 0 1 0 1 |
| 4 | 0 1 1 0 |
| 5 | 0 0 1 1 |

The size of the bitmap can correspond to the number of valid SA subframes in a scheduling or SA period or a smaller number. In certain embodiments, the number of subframes of the SA T-RPT pattern bitmap is preconfigured or fixed in the specifications. In certain embodiments, the number of subframes of the SA T-RPT pattern bitmap are indicated by higher layer signaling (e.g. RRC or SIB) or are dependent on the network configuration such as carrier frequency or duplex configuration (e.g. per TDD configuration). For example the pattern 0101 may have a different interpretation depending on if FDD or a given TDD configuration is utilized on the D2D carrier.

The allocation of frequency resources for SA transmissions may also be configured and indicated by the network along with the time resources. Within a single SA transmission period, time/frequency resources for both transmission instances of the SA by the transmitting UE should be configured such that UEs transmitting a SA have opportunities to obtain the SAs of other transmitting UEs within the same periodic SA transmission cycle.

For example if the SA T-RPT is of length N=6 and the SA is transmitted twice within a scheduling period, six SA T-RPT patterns may be possibly configured. Table 3 illustrates the possible resource allocation for UEs given a SA resource pool size of N_SARB=3 PRBs and N_T=4 subframes. Up to 6 UEs can be supported considering the half-duplex constraint wherein the SA resource allocations allow at least one transmission of each UE to be received by all other UEs.

TABLE 3
Example SA time/frequency allocation

| | | | |
|---|---|---|---|
| m = 2 | m = 2 | m = 2 | m = 2 |
| m = 1 | m = 1 | m = 1 | m = 1 |
| m = 0 | m = 0 | m = 0 | m = 0 |
| t = 0 | t = 1 | t = 2 | t = 3 |

| UE Index | Starting RB Index (m) | SA-TRPT Index |
|---|---|---|
| 0 | 3 | 1010 |
| 1 | 2 | 1001 |
| 2 | 1 | 1100 |
| 3 | 3 | 0101 |
| 4 | 0 | 0110 |
| 5 | 1 | 0011 |

In certain embodiments, the starting frequency resource for the first SA transmission is indicated along with a SA T-RPT pattern or pattern indicator. Any subsequent SA transmissions (e.g. one or more SA transmissions) utilize the same frequency resources (e.g. one or more RBs) as the first transmission. This joint time/frequency allocation for SA resources is illustrated in Table 3. It should be noted that orthogonal time/frequency allocation is not always be achieved depending on the network resource allocation scheme or if UEs autonomously select the time/frequency resources for SA transmissions.

In certain embodiments, inter-subframe frequency hopping is supported for D2D data communication in general and SA transmission specifically if multiple subframe transmission is utilized. For example the hopping may be based upon PUCCH or PUSCH Type 1 or Type 2 hopping or may be based on a general pattern that is (pre)configured or fixed in the specifications. Different hopping configurations may be applied to SA and data transmissions.

Given a certain SA resource pool and time/frequency resource that is used for a transmission of an SA message by a UE, the other time/frequency resources used by the same UE for transmission(s) of the same SA message within an SA resource period should be known at the receiving UE. A simple deterministic time/frequency hopping pattern should be applied in the case that two subframes are utilized for transmitting a SA and one repetition.

The SA hopping mapping pattern may be based upon an index set and a predefined symmetric frequency hopping across transmission instances. Each allocation is associated with an index m, where m can take a value {0, . . . N_SARB-1} where N_SARB is the number of RBs allocated for SA transmission in the SA resource pool. If a UE is allocated index m in time slot t, in time slot t+1, the UE will be allocated with the frequency symmetric RB of the time t allocation. Table 4 gives an example hopping pattern for SA T-RPT of size N=5 and a SA resource pool comprising five time slots (N_T=5) and N_SARB=4. In this case up to 10 UEs can be multiplexed in time/frequency while supporting the SA half-duplex constraint.

TABLE 4
Example SA time/frequency allocation
with frequency hopping

| | | | | |
|---|---|---|---|---|
| m = 3 | m = 3 | m = 3 | m = 3 | m = 3 |
| m = 2 | m = 2 | m = 2 | m = 2 | m = 2 |
| m = 1 | m = 1 | m = 1 | m = 1 | m = 1 |
| m = 0 | m = 0 | m = 0 | m = 0 | m = 0 |
| t = 0 | t = 1 | t = 2 | t = 3 | t = 4 |

| SA | Starting RB | SA-TRPT |
|---|---|---|
| Index | Index (m) | Index |
| 0 | 3 | 10100 |
| 1 | 2 | 10010 |
| 2 | 1 | 11000 |
| 3 | 3 | 01010 |
| 4 | 0 | 01100 |
| 5 | 1 | 00110 |
| 6 | 1 | 01001 |
| 7 | 2 | 00101 |
| 8 | 3 | 00011 |
| 9 | 0 | 10001 |

In another example, the time/frequency hopping pattern may be split across one or more frequency subsets. For example, the total bandwidth reserved for SA transmissions may be split into two equal subsets and the configured transmissions of the SA in different subframes are allocated frequency resources in the different subsets. In this case, the frequency RBs of the different SA transmissions may be independent of each other, except that they are within the different SA frequency subsets. Alternatively, the separate SA frequency transmissions may be separated based on a fixed frequency offset (e.g. the size of the frequency subset or floor(Nf/X) if the number of total frequency resources Nf is not an integer multiple of the number of subsets X). The fixed frequency offset may be preconfigured or configured or a function of the total number of frequency resources Nf and/or the number of SA frequency subsets X. The offset may be designed such that the other SA transmissions are always within different frequency subsets. Table 5 below gives an example joint time/frequency mapping with a fixed frequency offset of floor(Nf/2)=4.

TABLE 5
Example SA time/frequency allocation with
fixed frequency hopping offset

| | t = 0 | t = 1 | t = 2 | t = 3 | t = 4 | t = 5 |
|---|---|---|---|---|---|---|
| m = 0 | 0 | 1 | 2 | 3 | 4 | 5 |
| m = 1 | 6 | 7 | 8 | 9 | 10 | 11 |
| m = 2 | 12 | 13 | 14 | 15 | 16 | 17 |
| m = 3 | 18 | 19 | 20 | 21 | 22 | 23 |
| m = 4 | 5 | 0 | 1 | 2 | 3 | 4 |
| m = 5 | 10 | 11 | 6 | 7 | 8 | 9 |
| m = 6 | 15 | 16 | 17 | 12 | 13 | 14 |
| m = 7 | 20 | 21 | 22 | 23 | 18 | 19 |

| | Starting | SA- |
|---|---|---|
| SA | RB | TRPT |
| Index | Index(m) | Index |
| 0 | 0 | 110000 |
| 1 | 0 | 011000 |
| 2 | 0 | 001100 |
| 3 | 0 | 000110 |
| 4 | 0 | 000011 |
| 5 | 0 | 100001 |
| 6 | 1 | 101000 |
| 7 | 1 | 010100 |
| 8 | 1 | 001010 |
| 9 | 1 | 000101 |
| 10 | 1 | 100010 |
| 11 | 1 | 010001 |
| 12 | 2 | 100100 |
| 13 | 2 | 010010 |
| 14 | 2 | 001001 |
| 15 | 2 | 010010 |
| 16 | 2 | 010010 |
| 17 | 2 | 001001 |
| 18 | 3 | 100010 |
| 19 | 3 | 010001 |
| 20 | 3 | 101000 |
| 21 | 3 | 010100 |
| 22 | 3 | 001010 |
| 23 | 3 | 000101 |

In addition, if more resources for SA transmissions are available than required for the number of UEs that need to transmit scheduling assignments in a given SA period, the time/frequency resource selection may provide flexibility, where the frequency resources are not necessarily one-to-one mapped to a given T-RPT pattern. The selection of the joint time/frequency resources may be chosen by the eNB or UE to meet half-duplex constraints for certain UEs, while other UEs may have overlapping time/frequency resources as illustrated in Table 6 where only 5 UEs are multiplexed in the SA time/frequency resource pool and UE4 and UE5 transmit both SAs in the same time slots.

TABLE 6
Example time/frequency SA for N_SARB =
4 SA and N_T = 4 subframes.

| m = 3 | | m = 3 | m = 3 | m = 3 |
|---|---|---|---|---|
| m = 2 | | m = 2 | m = 2 | m = 2 |
| m = 1 | | m = 1 | m = 1 | m = 1 |
| m = 0 | | m = 0 | m = 0 | m = 0 |
| t = 0 | | t = 1 | t = 2 | t = 3 |
| UE 1 | UE 2 | UE 3 | UE 4 | UE 5 |

While the alternatives described in Embodiments 1 and 2 may be utilized for separate time and frequency allocations, the above bit fields and mapping tables may be constructed to allow for joint time/frequency allocation. This may be beneficial in the case that only a subset of time/frequency allocations are likely to be utilized by a D2D system and joint indication may reduce the amount of necessary control overhead, improving the efficiency of the D2D air interface. For example, the time/frequency fields may map to an index that corresponds to a pattern of DRBs and a T-PRT pattern in D2D subframes as shown in Tables 4 and 5. These patterns may be explicitly signaled by the SA, (pre)configured by higher layers, or fixed in the specification. For example, the preconfigured pattern may be expressed as a function with one or more input variables including a SA resource index. Alternatively, the pattern may be equivalently expressed as precomputed tables based on the mapping function and indexed by the SA resource index. The UE may switch between the precomputed tables based on the SA resource pool configuration.

As mentioned previously, in the DCI carrying the SA grant may reserve a field for indicating the SA resources with a SA resource index. This SA resource index is an index into the SA resource pool and indicates both time and frequency dimensions. The mapping of the indices to the pool is fixed in the specification or configured by higher layer signaling. The resource allocation information for SA time resources may be based on a T-RPT pattern index.

The resource allocation information for SA frequency resources may follow the principles of existing uplink resource allocation types such as localized RB allocation since the D2D data transmission are based on the PUSCH structure. As a result, Uplink Type 0 resource allocation may be taken as the starting point for the frequency resource signaling for the SA.

### Example 1

The SA resource index can indicate to the Tx UE the SA resource block (SARB_{START}) based on a SA resource indication value (SARIV). The SARIV can be defined similarly as the RIV in Type 0 resource allocation, however if the length of contiguously allocated SARBs=1 the SARIV is simply the index of the SA resource block:

SARIV=SARB_{START}

### Example 2

The SA grant can indicate a starting D2D resource block (SARB_{START}) and a length of contiguously allocated RBs (L_{SARBS}≧1) based on a D2D resource indication value (SARIV). The SARIV can be defined as:

if(L_{SARBs}−1)≦└N_{SARB}^{UL}/2┘ then

SARIV=N_{SARB}^{UL}(L_{SARBs}−1)+SARB_{START}

else

SARIV=N_{SARB}^{UL}(N_{SARB}^{UL}−L_{SARBs}+1)+(N_{SARB}^{UL}−1−SARB_{START})

Combining the time/frequency resource indication method defines the joint SA resource index according to the alternatives described below.

Alternative 1: The N_SA bits in the DCI for indicating the SA resource index comprise the following:
x bits for RB indication of the 1st SA transmission
y bits for SA T-RPT indication
The values of x and y are (pre)configured by higher layers or fixed in the specification

The values of x and y are dependent on the number of valid SA T-RPT patterns and the number of RBs within the SA resource pool. For example, if the maximum number of RBs is 50 for SA, if x=4, the number of bits is not sufficient to fully index all possible RB starting locations. In this case, RRC signaling may be used to indicate the mapping into one or more sets of 16 RBs, which map to the system bandwidth in a predefined manner.

Alternative 2: The N_SA bits in the DCI for indicating the SA resource index comprise the following:
x bits for RB indication of 1st SA transmission
   RRC signaling may be used to indicate to which set(s) of RBs the x bits correspond, and the resulting mapping to the system bandwidth
y bits for SA T-RPT indication
The values of x and y are (pre)configured by higher layers or fixed in the specification

Again, the values of x and y are dependent on the number of valid SA T-RPT patterns and the number of RBs within the SA resource pool. For example, since the maximum number of RBs is N_SARB=50 for the SA resource pool, if x=4, 2-bit RRC signaling may be used to indicate the mapping into one or more sets of 16 RBs, which map to the system bandwidth in a predefined manner.

Alternative 2A: The mapping of the SA resource pool subsets may correspond to an equal division of the SA resource pool where the number of required subsets is given by N_SARB/2̂x.

Alternative 2B: The mapping of the SA resource pool subsets may correspond to a mapping of the SA resource pool where the SA resource pool subset is mapped using a bitmap to the system bandwidth.

Alternative 2C: The mapping of the SA resource pool subsets may correspond to a mapping of the SA resource pool where the SA resource pool utilizes a range of RBs for the SA resource pool comprising one or more of a number of RBs, starting RB and ending RB.

Alternative 2D: The mapping of the SA resource pool subsets may correspond to an implicit mapping of the SA resource pool based on a value of the SA resource index or T-RPT pattern index.

Alternative 2E: The mapping of the SA resource pool subsets may correspond to a (pre)configured mapping based on a SA resource pool index which may be carried by higher layer signaling (e.g. RRC or SIB) or is preconfigured.

Alternative 3: The N_SA bits in the DCI for indicating the SA resource index comprise a SA resource index indicating the following:
RB indication of 1st SA and 2nd SA transmission
SA T-RPT indication

The resource index is used to derive the frequency and time location based on a predefined mapping function and/or an equivalent predefined table indexed by the SA resource index. The mapping function and/or table may be a function of both the frequency and time configuration of the SA resource pool. For example, a UE may utilize different tables for a mapping to a T-RPT index and RBs for SA transmission based on the total size of a configured SA resource pool including the number of configured subframes and number of RBs.

Depending on the deployment scenario, a UE may be configured with multiple SA resource pool configurations, for example to support multiple different priority communication sessions, or to support communication inside or outside of network coverage. As a result, one or more SA resource pools may overlap in time and/or frequency resources. In case of such overlaps, a UE may need to prioritize the transmission or reception of SA resources.

In certain embodiments, a priority indicator may be provided by higher layer signaling for each resource pool (e.g. SIB, RRC, or application layer message) or may be preconfigured.

In certain embodiments, a priority indicator may be carried by physical layer or MAC signaling for each SA transmission or by another physical control channel (e.g. PD2DSCH). For example, the priority indication may be carried by one or more bits in the PHY or MAC signaling indicating an absolute or relative priority.

In certain embodiments, the priority indicator may be implicitly carried by a ID (e.g. group ID). In one example, the ID to priority mapping may be configured by higher layers or application layers (e.g. explicit mapping table from ID to priority level). In a second example, the ID to priority mapping may be carried through numerical ordering of ID (e.g. ID 32 has a lower priority than ID 31). The ID to priority mapping may also be accomplished through the mapping function of a higher layer or application layer ID to a L1/L2 ID. For example, a UE may be configured with a smaller number of L1/L2 IDs compared to the number of configured higher layer or application layer IDs. Therefore, a mapping function/table may be defined for mapping a higher/application layer ID to a L1/L2 ID. The mapping function ordering may sort the L1/L2 IDs in order of priority. For example, higher layer ID 32 may be mapped to a L1 ID=1 if it is the highest priority, or L1 ID=2 if it is the second highest in priority. In a further example, a L1 ID=1 may be reassigned to L1 ID=2 if a reconfiguration adds an additional higher layer ID with a greater priority which results in a L1 ID=1 of the newly configured ID.

In certain embodiments, the same priority may apply to a SA pool for both transmission and reception.

In certain embodiments, the priority may apply independently to SA transmissions and receptions. The mapping functions described by the alternatives above may additionally be configured and/or applied separately in case of SA transmission or reception.

In certain embodiments, the priority may be applied in the case of an overlap of a SA transmission and a SA reception. In one example, the SA transmission or reception may be always prioritized depending on the indicated priority using one of the above alternatives. In a second example the transmission or reception of a SA may always be prioritized regardless of the indicated priority. In other words, the network or UE may configure, preconfigure, or have fixed in the specification the UE behavior depending on the SA flow direction (e.g. transmission or reception).

In certain embodiments, the SA priority may be applied depending on power metrics (e.g. transmission power, power required for reception, battery level). These thresholds may be configured, preconfigured, or fixed.

In certain embodiments, one or more metrics may be utilized to determine SA priority including PHY/MAC/TCP/application layer throughput and QoS, round robin or proportional fair (PF) scheduling metrics. For example, a SA flow with a higher delay threshold may be dropped compared to a SA flow with a lower delay threshold. A UE may compute the scheduling weights (e.g. equal for round robin or weighted for PF) according to preconfigured, configured, or fixed values, which may be determined per resource pool or per SA transmission/reception flow.

In certain embodiments, the SA priority may be applied based on whether one of the SA transmission/receptions is associated with a new transmission/reception flow or is part of an ongoing transmission/reception flow. In one example, the ongoing SA transmission/reception flows are always prioritized over new flows in order to maintain the quality of the ongoing flows.

In certain embodiments, the SA priority may be applied based on the type of data transmission associated with the SA pool or transmission/reception. In one example, the type of transmission may correspond to public safety vs. non-public safety communication flows. In a second example, the type of transmission may correspond to Rel.12 vs. Rel.13 LTE transmission/reception flows. In a third example, a type of transmission may correspond to broadcast, groupcast, or unicast transmission (e.g. broadcast>groupcast>unicast for SA priority). The examples may be further combined to introduce additional priority combinations.

Although in one alternative the configured priorities may be unique for each SA pool or transmission/reception, it is possible that the network may configure equal priorities for certain SA pools or transmissions/receptions. In this case, additional steps need to be applied by the UE to determine which SA to transmit and/or receive. For example, the UE may determine the SA to transmit or receive for equal priority overlaps based on the SA flow direction (transmission or reception) or any of the other alternatives described in the previously in the embodiment. In a second example, the UE may utilize one or more additional parameters or metrics as described above to determine the equal priority overlap behavior. The determination may also be applied at the application layer and/or based on manual user input (e.g. pressing a button to prioritize one transmission/reception flow). It should be noted that combinations of the above alternatives can also be considered to introduce further priority combinations.

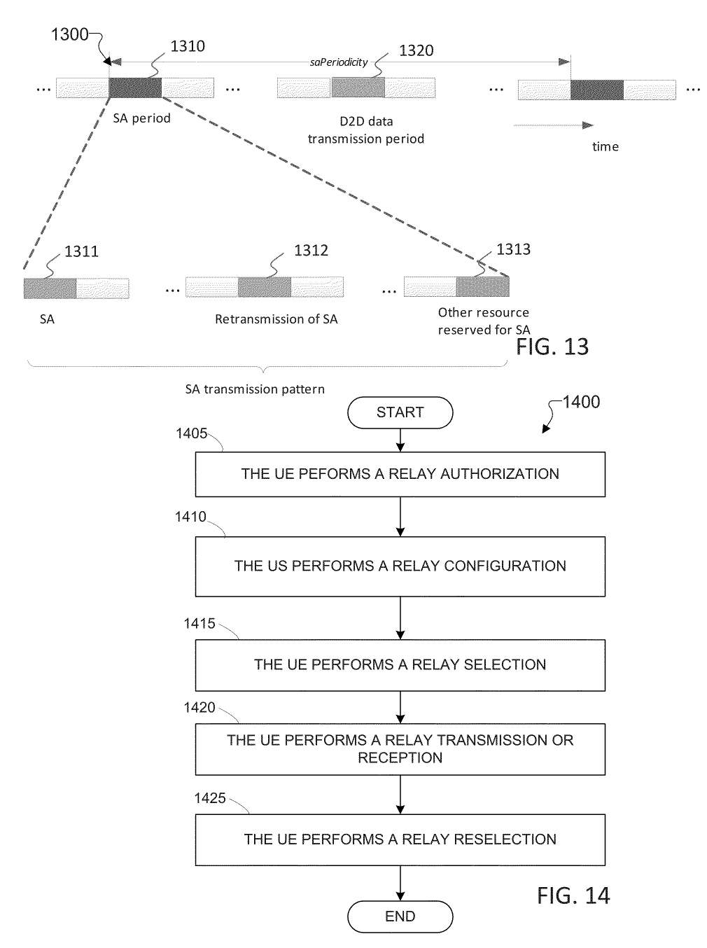

FIG. 14 illustrates a relay operation for one or more UEs to act as a UE-to-Network relay according to various embodiments of the present disclosure.

In operation 1405, the network performs a relay authorization for a UE. In operation 1410, the network performs a relay configuration for the UE. In operation 1415, the network performs a relay selection for a UE. In operation 1420, the network performs a relay transmission or reception for the UE.

In operation 1425, the network performs a relay reselection for the UE. The relay reselection can occur after a given relay period. The network or the UE can receive a message to perform any of the relay operation given an indicated relay configuration. The steps will be described in more detail below in the different embodiments presented.

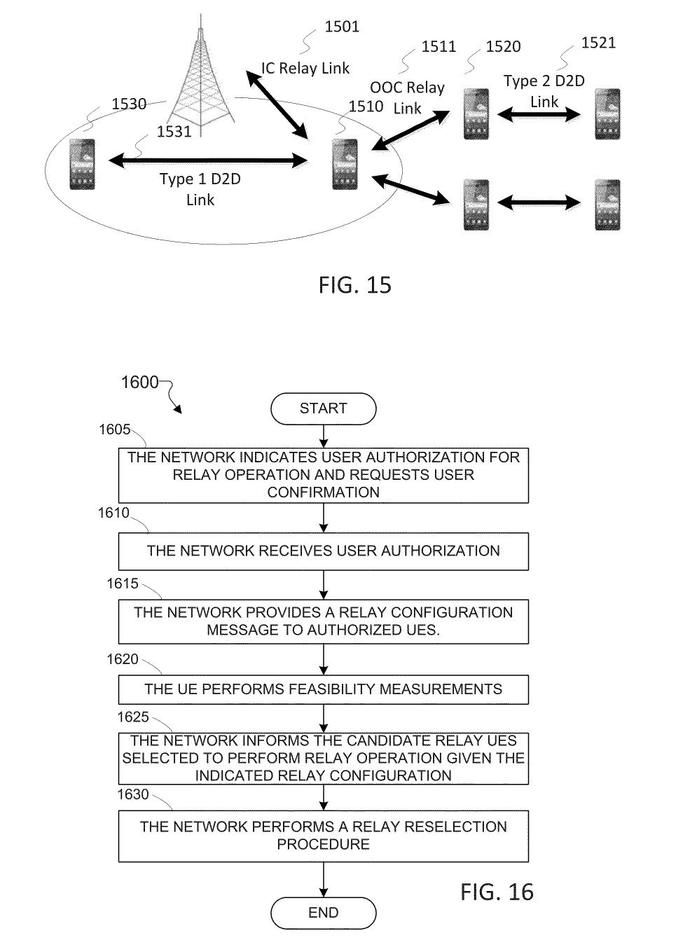

FIG. 15 illustrates a D2D relay deployment according to various embodiments of the present disclosure.

A D2D UE located within network coverage 1510, but capable of communicating with one or more UEs that are in coverage (IC) 1530 or out of network coverage (OOC) 1520 via Type 1 1531 and Type 2 1521 D2D broadcast communication links respectively may also serve as a UE-to-network for one or more UEs using in coverage relay link 1501 and out of coverage relay link 1511.

The network/eNB 1500 may configure a UE to serve as a D2D UE-to-network relay depending on multiple factors such as device capability, proximity measurement to other UEs, group membership, coverage location, device power metrics, traffic metrics/characteristics, and network/user/application preferences, authorization, and or indication.

This authorization may be set as a preconfiguration, or implicit based on the general D2D configuration from the network (e.g. based on D2D capability, group membership, or resource configuration). For example a UE capable of transmitting PD2DSCH may also be configured to act as a UE-to-Network relay.

A UE may be configured to act as a UE-to-Network Relay utilizing a higher layer (e.g. L2, L3, or application layer) control message indicating the necessary configuration information to support a relay link between the Relay UE 1510 and the eNB 1500 as well as the OOC UE 1520. The configuration may include one or more of the following fields/parameters:

1) Relay authorization/indicator

2) Relay source ID(s)

3) Relay destination ID(s)

4) Group ID(s)

5) D2D broadcast source ID(s)

6) D2D broadcast destination ID(s)

7) Priority indicator(s)
a) Dedicated relay resource configuration
b) D2D Relay resource pool

8) Cellular resource indication

9) Scheduling, multiplexing factor/ratio

10) Relay selection criteria parameters

11) Relay transmission direction (e.g. Network-to-UE or UE-to-Network)

12) Traffic Type (e.g. VoIP, Video, App identifier)

Once relay authorization, configuration, and selection steps have been completed at the relay UE, the relay transmission/reception may be performed. For example, the relay UE may receive a broadcast message from one or more OOC UEs. If relay filtering using destination/source IDs is utilized the UE may determine that one or more IDs is associated with relay operation. For example, a given source or destination ID may be preconfigured or configured as a dedicated relay ID. Any communication messages received with the relay ID are automatically processed according to the relay protocol.

Alternatively, a dedicated ID may not be configured, but instead a set of one or more IDs are indicated in a (pre)configuration message as corresponding to relay operation. For example if a message with source ID 200 and destination ID 100 is received at the relay UE, the UE will check the list of relay-associated IDs and if both or either of those IDs are part of the list, the UE will process the message according to the relay protocol. In a third alternative, a UE may be configured to relay traffic based on the traffic type or direction. For example, a UE may be configured to only relay video traffic corresponding to a certain application or only relay traffic received from the OOC UEs to the eNB, while traffic in the reverse direction is not relayed to the OOC UEs.

The relay transmission/reception processing protocol may correspond to different steps depending on the layer of abstraction for the relay (e.g. L3 or application layer). In one alternative, a UE may receive L3 packet(s) from one or more OOC UEs as part of a D2D broadcast communications session. The UE after determining the relay criteria is successfully met (according to the previously described methods) will transfer the corresponding L3 packets from the D2D reception buffer into the cellular transmission buffer. In addition, the UE may indicate in the higher layer description (e.g. L3, TCP, RLC, or application layer header) parameters indicating that these packets are relayed from the OOC UE and the origin is not the relay UE. This may include for example including a relay flag, switching the relay UE source ID with the OOC UE source ID, and/or replacing the eNB destination ID with a dedicated relay destination ID.

The packets may be decoded and re-encoded different according to the relay link characteristics and different control fields may be added or removed. This is because the eNB relay link will utilize the cellular dedicated resources, while the D2D relay link will utilize dedicated D2D resources. Alternatively, the packets may be passed from the reception to transmission buffer without any modifications if the process is transparent to the lower layers (e.g. L3 and below). A similar procedure can be applied for eNB-to-UE traffic by receiving the L3 packets on the cellular link and moving the packets and re-encoding/encapsulating the packets using the D2D transmission procedure.

Furthermore, the protocol may include steps for bundling the packets of one or more relay traffic flows to provide more efficient transmission on either the cellular or D2D relay links. This may be beneficial in order to prevent degradation of the non-relay traffic sent/received by the relay UE while it is simultaneously configured to act as a UE-to-Network relay. For example, the packets from one or more OOC D2D UEs that are members of the same D2D group. To support this operation, a packet bundling field may be added to the packets which provide information about the number of flows to be combined, including the relevant flow IDs (e.g. source/destination IDs) as well as packet size and ordering fields. If the flows are multiplexed, they may be indexed according to flow ID or interleaved. In addition, the size of the bundled packets may be fixed and the ratio of packets for each flow to be bundled may be fixed to be equally divided or weighted for each flow based on different (pre)configured criteria such as priority, traffic type, traffic QoS value, group ID, or source/destination ID.

In certain embodiments, a UE may be configured to act as a UE-to-network relay utilizing higher layer (e.g. L2, L3, or application layer) messages abstracting the relay protocol from the lower layers, and making the relay process transparent to the radio access protocol (e.g. RLC or TCP and below). This may be beneficial to support over-the-top (OTT) applications which are agnostic to the RAT utilized to transmit the messages (e.g. D2D, cellular, Wi-Fi Direct) and may switch between or simultaneously use different RATs for one or more traffic flows. In this case, a relay packet may be passed directly from the radio access layers to the application layer where an application layer header may be added to the relay packets to indicate the source/destination IDs as well as any lower-layer packet indexing parameters for different relay flows, while the lower layers process all packets from the application in the same manner (e.g. using the same source/destination IDs).

As mentioned in the previous embodiment, relay selection (and reselection) may be steps which are included in a UE-to-network protocol. The selection process may depend on multiple factors such as device capability, proximity measurement to other UEs, group membership, coverage location, device power metrics, traffic metrics/characteristics, and network/user/application preferences, authorization, and or indication.

These factors may be transmitted as part of a relay selection feasibility report using higher layer or application layer signaling. The network/eNB may utilize a hierarchy of one or more factors with different weights or priority to determine whether a given set of candidate relay UEs may be selected for relay operation. For example the following decision matrix may be utilized to determine a “feasibility” criteria for selection:

| Feasibility Rank | Battery Power | Proximity Criteria | Traffic Level |
|---|---|---|---|
| 1 | >50% | Strong | Low |
| 2 | >50% | Weak | Low |
| 3 | <50% | Weak | Low |
| 4 | <50% | Strong | High |

The eNB may prioritize relay selection for the UEs with the lowest feasibility ranks, while UEs that do not meet the criteria for the lowest feasibility rank are excluded from consideration.

Relay selection based on proximity metrics may include generating a candidate set of relay UEs based on a device discovery procedure. Where the results of the procedure are forwarded to the network to determine candidate relay UEs based on which of the OOC UEs were discovered by the relay candidate UEs. For example, the relay selection may be based on the minimum number of UEs required to serve all of the discovered OOC UEs.

In addition to device discovery, measurements may be utilized as part of the network discovery process. In one example, the measurements for relay selection are based upon the transmissions received by different candidate relay UEs. Transmissions may include PD2DSS, PD2DSCH, SA or D2D Data, or other control or data transmissions.

In one alternative, based upon the number of OOC PD2DSS transmissions (or other D2D transmission signal or message) received at different UEs the network may determine a set of relay UEs to cover the maximum number of OOC UEs transmitting PD2DSS with the minimum or fixed number of relay UEs.

In a second alternative, the eNB may determine a (pre)configured threshold X and a fixed number of relay nodes N. If the UE measures more than Y D2D transmissions about the threshold X (e.g. −92 dBm), then it is a candidate for relay operation. The eNB selects the relay UEs with the strongest received power above X. Multiple thresholds X1, X2, etc. may be used to correspond to different proximity criteria such as strong, weak, for use in a feasibility report or decision matrix.

These measurements may be 1) autonomously performed by the UE and reported based on a given reporting criteria, 2) scheduled by the network on a periodic basis or 3) aperiodic with a physical layer or control layer signaling trigger message.

FIG. 16 illustrates an exemplary process 1600 for relay selection according to the various embodiments of the present disclosure.

In operation 1605, the network indicates user authorization for relay operation and requests user confirmation in a higher layer or application layer message. In operation 1610, the network receives the user authorization for relay operation in a higher layer or application layer message. In operation 1615, the network provides relay configuration message to authorized UEs. In operation 1620, if relay selection measurements or feasibility reports are configured, the UE performs those measurements and transmits a measurement report/feasibility report. In operation 1625, the eNB informs the candidate relay UEs selected to perform relay operation given the indicated relay configuration. In operation 1630, after a given relay period (e.g. relay timer expires) the network or UE may performs one or more of the above steps as part of a relay reselection procedure.

It should be noted that not all steps such as network/user authorization or configuration need to be performed every selection cycle, but could be performed with larger periodicities. In addition, the UE may autonomously perform one or more of the steps.

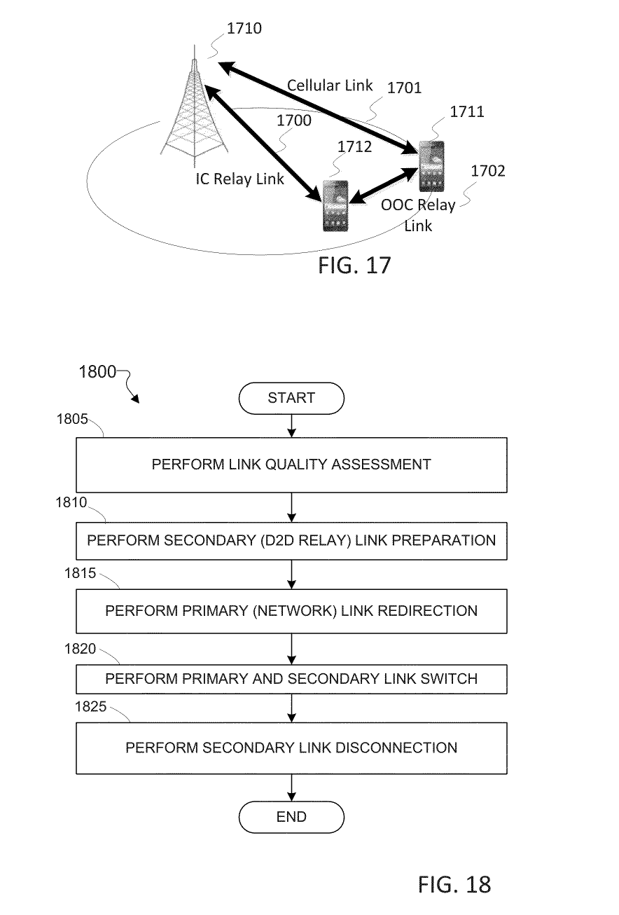

FIG. 17 illustrates a D2D relay service continuity according to various embodiments of the present disclosure.

One additional aspect to support UE-to-Network D2D relays is define a mechanism to move traffic between a direct cellular link between a eNB and a UE and a relay link with one or more relay-enabled UEs providing the intermediate links. The criteria used to determine which type of link(s) should be used to serve the traffic may be based on network policy and user choice. As a result, a mechanism to support service continuity is needed when the traffic is moved from one type of link to another.

FIG. 17 provides an example of a service continuity scenario where the UE on the boundary of network coverage 1711 may either be served by the cellular link 1701 from the eNB or served by the eNB and UE-to-Network relay 1712 with the IC 1700 and OOC relay links 1702.

In one example, the system may directly indicate for a given traffic flow, which type of link to utilize. In a second example, the user may indicate a preference for which link to utilize or may directly override any command to move a link from one type of link to another using an application layer control message.

FIG. 18 illustrates an exemplary method for service continuity from network link to relay link according to various embodiments of the present disclosure.

In operation 1805, the system performs a link quality assessment. In operation 1810, the system performs a secondary (D2D relay) link preparation. In operation 1815, the system performs a primary (network) link redirection. In operation 1820, the system performs a primary and secondary link switch. In operation 1825, the system performs a secondary link disconnection.

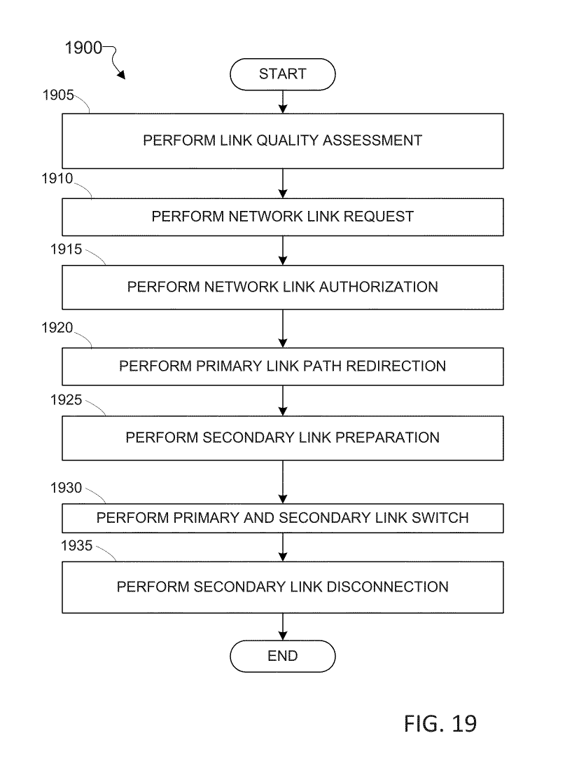

FIG. 19 illustrates an exemplary method 1900 for service continuity from relay link to network link according to various embodiments of the present disclosure.

In operation 1905, the system performs a link quality assessment. In operation 1910, the system performs a network link request. In operation 1915, the system performs a network link authorization. In operation 1920, the system performs a primary link path redirection. In operation 1925, the system performs a secondary link preparation. In operation 1930, the system performs a primary and secondary link switch. In operation 1935, the system performs a secondary link disconnection.

It should be noted in FIGS. 18 and 19 that the network may initiate these steps or the UE may autonomously initiate one or more of the steps. The link quality assessment may be performed by the OOC UE using the existing cell-search and association procedure and by the network utilizing existing RRM/RLF and D2D relay selection feasibility measurements. For example, when the network determines a UE has a cellular received power<=X dBm for a given duration T (e.g. RLF timer or new D2D relay timer) the network may determine to initiate relay operation and prepare the secondary link. Alternatively, when the network determines a UE has a cellular received power>X dBm for a given duration T (e.g. RLF timer or new D2D relay timer) the network may determine to initiate cellular operation and prepare the secondary link.

In one alternative, once the relay UE has been activated, the network may immediately discontinue traffic flow on the primary channel and instead direct the entire flow onto the secondary channel. In the second alternative, both the cellular and D2D traffic flows may continue until a higher layer or application layer traffic switch message has been received at the eNB, confirming from the OOC UE that the traffic flows are established and stabilized at which time the secondary (eNB or D2D relay) may be disconnected. In a third alternative, the eNB may perform the switch but the D2D relay channel continues to serve the OOC UE until a service continuity timer has expired. The timer may be triggered once a path switch notification is received by the relay UE.

Although the present disclosure has been described with an exemplary embodiment, various changes and modifications may be suggested to one skilled in the art. It is intended that the present disclosure encompass such changes and modifications as fall within the scope of the appended claims.

None of the description in this application should be read as implying that any particular element, step, or function is an essential element that must be included in the claim scope. The scope of patented subject matter is defined only by the claims. Moreover, none of the claims is intended to invoke 35 U.S.C. §112(f) unless the exact words “means for” are followed by a participle.

What is claimed is:

1. A user equipment (UE) comprising:
a transceiver; and
one or more processors operably connected to the transceiver, the one or more processors configured to:
receive, via the transceiver, a network allocation of resource configurations from a base station;
select a set of resources from the network allocation of resource configurations based on a priority rule; and
transmit, via the transceiver, the selected set of resources to one or more other UEs.

2. The UE of claim 1, wherein the priority rule comprises a priority indicator provided by a higher layer signaling for each of a plurality of resource pools.

3. The UE of claim 1, wherein the priority rule comprises a priority indicator implicitly carried by an identification for each of a plurality of resource pools.

4. The UE of claim 1, wherein the priority rule comprises a priority indication based on a type of data transmission associated with each of a plurality of resource pools.

5. The UE of claim 1, wherein the one or more processors are further configured to:
receive, via the transceiver, a message for UE-to-network relay selection;
perform a feasibility measurement; and
transmit, via the transceiver, the feasibility measurement to the base station (BS).

6. The UE of claim 1, wherein the one or more processors are further configured to perform a relay reselection procedure after a given relay period.

7. The UE of claim 1, wherein the one or more processors are further configured to receive, via the transceiver, a message to perform a relay operation given an indicated relay configuration.

8. A base station (BS) configured to communicate with a plurality of UEs, the base station comprising:
a transceiver; and
one or more processors operably connected to the memory, the one or more processors configured to:
configure a network allocation of resource configurations; and
transmit, via the transceiver, the network allocation of resource configurations to a user equipment (UE).

9. The BS of claim 8, wherein the priority rules comprises a priority indicator provided by a higher layer signaling for each of a plurality of resource pools.

10. The BS of claim 8, wherein the priority rule comprises a priority indicator implicitly carried by an identification for each of a plurality of resource pools.

11. The BS of claim 8, wherein the priority rule comprises a priority indication based on a type of data transmission associated with each of a plurality of resource pools.

12. The BS of claim 8, wherein the one or more processors are further configured to:
transmit, via the transceiver, a message for UE-to-network relay selection to authorized UEs;
receive, via the transceiver, a feasibility measurement from each of the authorized UEs; and
select, via the transceiver, a candidate UE based on the feasibility measurement received from the authorized UEs.

13. The BS of claim 8, wherein the one or more processors are further configured to perform a relay reselection procedure after a given relay period.

14. The BS of claim 8, wherein the one or more processors are further configured to transmit, via the transceiver, a message to perform a relay operation given the indicated relay configuration.

15. A method for operating a user equipment (UE), the method comprising:
receiving a network allocation of resource configuration to the UE;
selecting a set of resources from the network allocation of resource configuration based on a priority rule; and
transmitting the selected set of resources to one or more other UEs.

16. The method of claim 15, wherein the priority rule comprises a priority indicator is provided by a higher layer signaling for each of a plurality of resource pools.

17. The method of claim 15, wherein the priority rule comprises a priority indicator is implicitly carried by an identification for each of a plurality of resource pools.

18. The method of claim 15, wherein the priority rule comprises a priority indication based on a type of data transmission associated with each of a plurality of resource pools.

19. The method of claim 15, further comprising:
receiving a message for UE-to-network relay selection;
performing a feasibility measurement; and
transmitting the feasibility measurement to the base station (BS).

20. The method of claim 15, further comprising performing a relay reselection procedure after a given relay period.
